(19) United States
(12) Patent Application Publication
(10) Pub. No.: US 2026/0333295 A1
(43) Pub. Date: Oct. 22, 2026

(54) METHOD, DEVICE AND COMPUTER STORAGE MEDIUM OF COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 19/113,304

(22) PCT Filed: Sep. 20, 2022
(86) PCT No.: PCT/CN2022/120014

§ 371 Date: Mar. 19, 2025

(51) Int. Cl. H04W 68/00; H04W 4/06; H04W 76/27

(52) U.S. Cl. CPC H04W 68/00; H04W 4/06; H04W 76/27

(57) ABSTRACT

Embodiments of the present disclosure relate to methods, devices and computer readable media of communication. In the method, a terminal device in an inactive state receives, from a network device, a paging message comprising a paging cause for a multicast session, and performs an operation for the multicast session based on the paging cause. The paging cause indicates a start, stop or modification of the multicast session. In this way, more information may be provided for a UE in an inactive state to differentiate paging information for a multicast session state.

### TECHNICAL FIELD

Embodiments of the present disclosure generally relate to the field of telecommunication, and in particular, to methods, devices and computer storage media of communication for multicast and broadcast service (MBS).

### BACKGROUND

To enable resource-efficient delivery of MBS, the third generation partnership project (3GPP) has developed new radio (NR) broadcast and multicast in Release 17. In Release 17, multicast is only specified for a connected state, which may not fully fulfil requirements of some services (e.g., mission critical services) especially for cells with a large number of UEs. In addition, to always keep UEs in a connected state is not power efficient. It is therefore important to support multicast for UEs in an inactive state. However, solutions of managing multicast reception in an inactive state are still incomplete and need to be further developed.

### SUMMARY

In general, embodiments of the present disclosure provide methods, devices and computer storage media of communication for multicast reception in an inactive state.

In a first aspect, there is provided a method of communication. The method comprises: receiving, at a terminal device in an inactive state and from a network device, a paging message comprising a paging cause for a multicast session, the paging cause indicating a start, stop or modification of the multicast session; and performing an operation for the multicast session based on the paging cause.

In a second aspect, there is provided a method of communication. The method comprises: transmitting, at a terminal device in an inactive state and to a network device, a first message for requesting a configuration for multicast reception in the inactive state; and receiving, from the network device, a radio resource control release message comprising the configuration.

In a third aspect, there is provided a method of communication. The method comprises: transmitting, at a network device and to a terminal device in an inactive state, a paging message comprising a paging cause for a multicast session, the paging cause indicating a start, stop or modification of the multicast session.

In a fourth aspect, there is provided a method of communication. The method comprises: receiving, at a network device and from a terminal device in an inactive state, a first message for requesting a configuration for multicast reception in the inactive state; and transmitting, to the terminal device, a radio resource control release message comprising the configuration.

In a fifth aspect, there is provided a device of communication. The device of communication comprises a processor configured to cause the device to perform the method according to any of the first to fourth aspects of the present disclosure.

In a sixth aspect, there is provided a computer readable medium having instructions stored thereon. The instructions, when executed on at least one processor, cause the at least one processor to perform the method according to any of the first to fourth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2A illustrates a schematic diagram of a unicast scenario in which some embodiments of the present disclosure can be implemented;

FIG. 2B illustrates a schematic diagram of a multicast scenario in which some embodiments of the present disclosure can be implemented;

FIG. 3 illustrates a schematic diagram illustrating a process of communication for multicast reception in an inactive state according to embodiments of the present disclosure;

FIG. 4 illustrates a schematic diagram illustrating another process of communication for a multicast reception in an inactive state according to embodiments of the present disclosure;

FIG. 5 illustrates an example method of communication implemented at a terminal device in accordance with some embodiments of the present disclosure;

FIG. 6 illustrates another example method of communication implemented at a terminal device in accordance with some embodiments of the present disclosure;

FIG. 7 illustrates an example method of communication implemented at a network device in accordance with some embodiments of the present disclosure;

FIG. 8 illustrates another example method of communication implemented at a network device in accordance with some embodiments of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “MBS” may be interchangeably used with “multicast”, “multicast service”, “multicast transmission” or “multicast data”. The term “multicast reception” may be interchangeably used with “MBS reception”. The term “a connected state” may be interchangeably used with “a RRC_CONNECTED state”, the term “an idle state” may be interchangeably used with “a RRC_IDLE state”, and the term “an inactive state” may be interchangeably used with “a RRC_INACTIVE state”.

A conventional MBS paging mechanism is merely used for notifying RRC_INACTIVE UE or RRC_IDLE UE of re-connecting with a network for multicast reception. Only a temporary mobile group identifier (TMGI) indication is comprised in a paging message. However, in Release 18, it is to support multicast reception in an inactive state. In some scenarios, some UEs may be receiving multicast in a connected state, and enter an inactive state to continue the multicast reception. In some scenarios, some UEs may have joined a multicast session and stay in an inactive state, but the multicast session is not started yet. In these scenarios, only a TMGI indication in a paging message is not sufficient.

In view of this, embodiments of the present disclosure provide solutions for multicast reception in an inactive state. In one solution, a network device transmits, to a terminal device in an inactive state, a paging message comprising a paging cause for a multicast session. The paging cause indicates a start, stop or modification of the multicast session. The terminal device performs an operation for the multicast session based on the paging cause. In this way, more information may be provided for a UE in an inactive state to differentiate paging information for a multicast session state.

In another solution, a terminal device in an inactive state transmits, to a network device, a message (for convenience, also referred to as a first message herein) for requesting a configuration for multicast reception in the inactive state. The network device transmits, to the terminal device, a radio resource control release message comprising the configuration. In this way, a UE may stay in an inactive state to adjust its configuration for multicast reception in the inactive state.

Principles and implementations of the present disclosure will be described in detail below with reference to the figures.

### Example of Communication Network

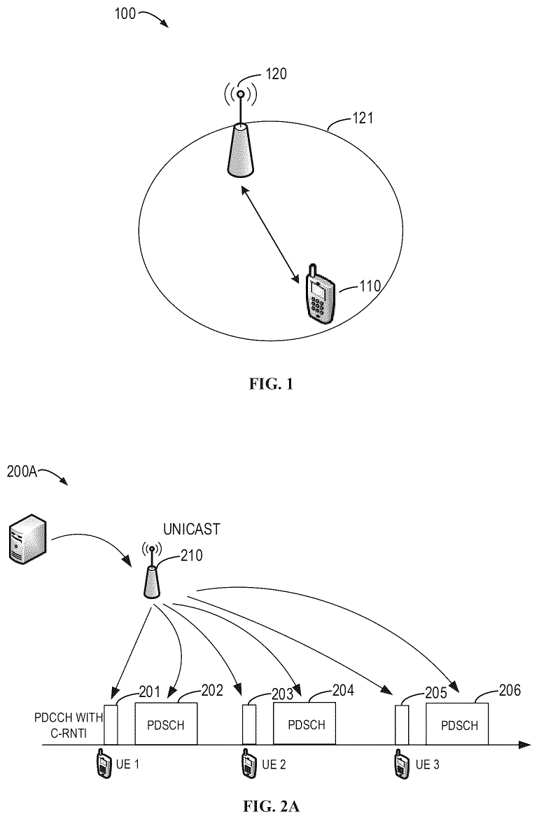

FIG. 1 illustrates a schematic diagram of an example communication network 100 in which some embodiments of the present disclosure can be implemented. As shown in FIG. 1, the communication network 100 may include a terminal device 110 and a network device 120. In some embodiments, the network device 120 may provide a serving cell (also referred to as a cell herein) 121 to serve one or more terminal devices. In this example, the terminal device 110 is shown as being located in the cell 121 and served by the network device 120.

It is to be understood that the number of devices or cells in FIG. 1 is given for the purpose of illustration without suggesting any limitations to the present disclosure. The communication network 100 may include any suitable number of network devices and/or terminal devices and/cells adapted for implementing implementations of the present disclosure.

As shown in FIG. 1, the terminal device 110 may communicate with the network devices 120 and 130 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

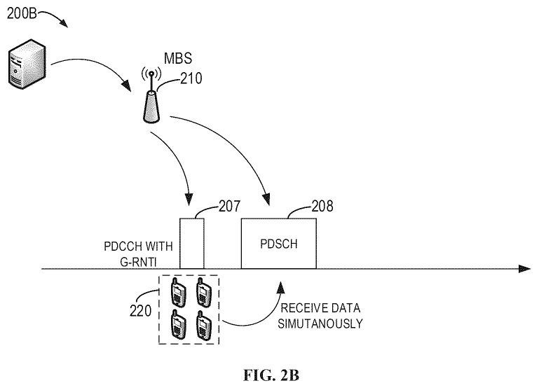

In some embodiments where the terminal device 110 is served by the network device 120, the terminal device 110 may receive a unicast service from the network device 120. FIG. 2A illustrates a schematic diagram of a unicast scenario 200A in which some embodiments of the present disclosure can be implemented. As shown in FIG. 2A, a base station 210 may transmit downlink control information (DCI) on a physical downlink control channel (PDCCH) 201 with a cell-radio network temporary identifier (C-RNTI) for UE1. In this way, UE1 may be scheduled to receive data (for example, video stream) on a physical downlink shared channel (PDSCH) 202 in unicast. Similarly, the base station 210 may transmit DCI on a PDCCH 203 with a C-RNTI for UE2 to schedule UE2 to receive the data on a PDSCH 204 in unicast. The base station 210 may transmit DCI on a PDCCH 205 with a C-RNTI for UE3 to schedule UE3 to receive the data on a PDSCH 206 in unicast.

In some embodiments where the terminal device 110 is served by the network device 120, the terminal device 110 may receive a multicast service from the network device 120. FIG. 2B illustrates a schematic diagram of a multicast scenario 200B in which some embodiments of the present disclosure can be implemented. As shown in FIG. 2B, the base station 210 may transmit DCI on a PDCCH 207 with a group-radio network temporary identifier (G-RNTI) for a set of UEs 220. In this way, the set of UEs 220 may be scheduled to receive the data on a PDSCH 208 in multicast, i.e., to receive the data simultaneously.

That is, for multicast communication service, the same service and the same specific content data are provided simultaneously to a dedicated set of UEs (i.e., not all UEs in the multicast service area are authorized to receive the data). A multicast communication service is delivered to the UEs using a multicast session. A UE can receive a multicast communication service in a connected state with mechanisms such as point-to-point (PTP) and/or PTM delivery.

In some embodiments, the terminal device 110 may receive data of MBS multicast session only in a connected state. If the terminal device 110 which joined a multicast session is in a connected state and when the multicast session starts, the network device 120 may transmit a radio resource control (RRC) reconfiguration message with relevant MBS configuration (also referred to as a multicast configuration) for the multicast session to the terminal device 110. In this case, there is no need for separate session activation notification for the terminal device 110.

In some embodiments, when there is no data to be sent to the terminal device 110 for a multicast session, the network device 120 may cause the terminal device 110 to enter an inactive state. In some embodiments, when a multicast session has been activated by a core network (CN) or the network device 120 has multicast session data to delivery, the network device 120 may use a group notification mechanism (i.e., multicast paging) to notify the terminal device 110 in an inactive state.

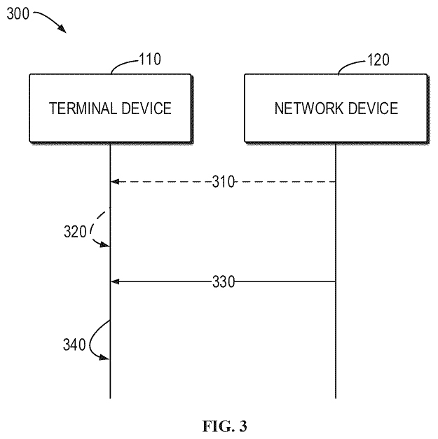

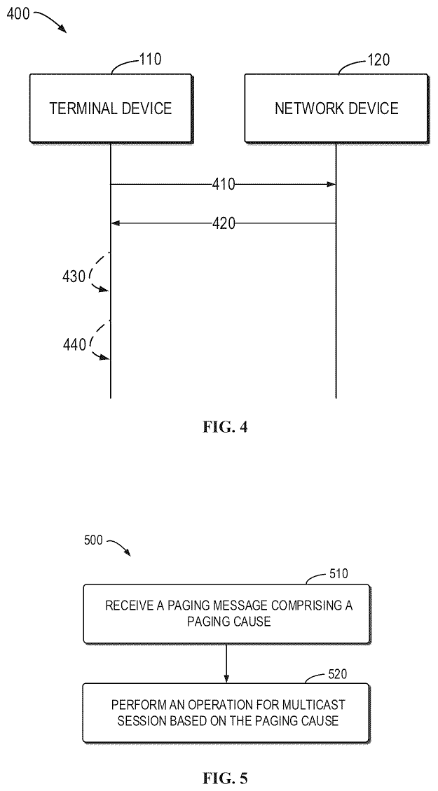

As mentioned above, a conventional MBS paging mechanism is merely used for notifying RRC_INACTIVE UE or RRC_IDLE UE of re-connecting with a network for multicast reception. Only one TMGI indication is comprised in a paging message. However, there may be three types of notifications for multicast in an inactive state, e.g., how to notify UE that a multicast session is stopped, modified and started. Thus, only one TMGI indication in a paging message is not sufficient for supporting multicast reception in an inactive state. Thus, embodiments of the present disclosure provide solutions for multicast reception in an inactive state so as to overcome the above and other potential issues. The detailed description will be made with reference to FIGS. 3 and 4 below.

### Example Implementation of MBS Paging

FIG. 3 illustrates a schematic diagram illustrating a process 300 of communication for multicast reception in an inactive state according to embodiments of the present disclosure. For the purpose of discussion, the process 300 will be described with reference to FIG. 1. The process 300 may involve the terminal device 110 and the network device 120 as illustrated in FIG. 1. It is to be understood that the steps and the order of the steps in FIG. 3 are merely for illustration, and not for limitation. For example, the order of the steps may be changed. Some of the steps may be omitted or any other suitable additional steps may be added. It is assumed that the terminal device 110 is in an inactive state.

As shown in FIG. 3, the network device 120 may transmit 310, to the terminal device 110, downlink control information (DCI) scheduling reception of a paging message. In some embodiments, the DCI may comprise an indication indicating that only multicast information is present in the paging message. For example, the DCI may comprise a short message indicator as shown in Table 1.

TABLE 1

| Bit Field | Short Message Indicator |
|---|---|
| 00 | Only scheduling information for MBS |
| | paging is present in the DCI |
| 01 | Only scheduling information for Paging |
| | is present in the DCI |
| 10 | Only short message is present in the DCI |
| 11 | At least two types of the above message |
| | are present in the DCI |

In this example, “00” is used to indicate that only pagingGroupList (i.e., MBS related paging) exists.

Upon reception of the DCI, if the terminal device 110 has not joined a multicast session in the inactive state, the terminal device 110 may skip 320 the paging message. For example, an example procedure may be described as below.

When the UE monitors paging PDCCH occasions, if the UE has not joined or interested in any MBS session when in RRC_INACTIVE, it is not required to schedule paging message in PDSCH when the short message indicator in paging DCI indicating 00.

With the indication indicating that only multicast information is present in the DCI, unnecessary paging reception may be avoided.

Continue to refer to FIG. 3, the network device 120 may transmit 330, to the terminal device 110, a paging message comprising a paging cause for a multicast session. In some embodiments, the paging cause may indicate a start of the multicast session. In some embodiments, the paging cause may indicate a start of the multicast session in an inactive state. In some embodiments, the paging cause may indicate a start of the multicast session in a connected state. In some embodiments, the paging cause may indicate a stop of the multicast session. In some embodiments, the paging cause may indicate a modification of the multicast session.

For example, a paging message may be configured as below.

| | |
|---|---|
| Paging ::= | SEQUENCE [symbol] |
| pagingRecordList | PagingRecordList |
| lateNonCriticalExtension | OCTET STRING |
| nonCriticalExtension | Paging-v1700-IEs |

[symbol]

[symbol]

| | |
|---|---|
| Paging-v1700-IEs ::= | SEQUENCE [symbol] |
| pagingRecordList-v1700 | PagingRecordList-v1700 |
| pagingGroupList | PagingGroupList |
| nonCriticalExtension | Paging-V1800-IEs [symbol] |

[symbol]

[symbol]

| | |
|---|---|
| Paging-V1800-IEs ::= | SEQUENCE { |
| pagingGroupList-v1800 | PagingGroupList-v1800 [symbol] |

[symbol]

[symbol]

| | |
|---|---|
| PagingGroupList ::= | SEQUENCE (SIZE(1..maxNrofPageGroup)) OF TMGI [symbol] |

[symbol]

| | |
|---|---|
| PagingGroupList-V1800 ::= | SEQUENCE (SIZE(1..maxNrofPageGroup)) OF PagingGroup-V1800 |

[symbol]

| | |
|---|---|
| PagingGroup-V1800 ::= | SEQUENCE [symbol] |
| pagingCause-MBS | ENUMERATED {start, stop, modification} [symbol] |

} [symbol] [symbol]
indicates data missing or illegible when filed

In this example, a paging cause (pagingCause-MBS) is introduced for a paging group list (PagingGroupList-V1800). The pagingCause-MBS indicates a state of a MBS session (e.g., TMGI) for a corresponding pagingGroup entry.

For example, the network device 120 may page two entries for MBS session by using PagingGroupList: TMGI1/TMGI2. These entries correspond to pagingGroupList-V1800 entry 1 (start) and entry 2 (modification). It means that MBS session 1 will be started soon and a configuration for MBS session 2 will be modified.

It is to be understood that the above example is merely for illustration, and is not intended for limitation.

Continue to refer to FIG. 3, upon reception of the paging message, the terminal device 110 may perform 340 an operation for the multicast session based on the paging cause.

In some embodiments where the paging cause indicates the start of the multicast session or indicates the start of the multicast session in an inactive state, if a configuration for multicast reception in the inactive state is available for the terminal device 110, the terminal device 110 may apply the configuration for reception of the multicast session in the inactive state. If the configuration is unavailable for the terminal device, the terminal device 110 may initiate a random access (RA) procedure for acquisition of the configuration.

In some embodiments where the paging cause indicates the start of the multicast session in a connected state, the terminal device 110 may initiate a RA procedure for acquisition of a configuration for multicast reception in the connected state, and receive the multicast session in the connected state based on the configuration.

In some embodiments where the paging cause indicates the stop of the multicast session, if the terminal device 110 is receiving the multicast session, the terminal device 110 may stop monitoring the multicast session, and store a configuration for the multicast session in the inactive state.

In some embodiments where the paging cause indicates the modification of the multicast session, the terminal device 110 may initiate a RA procedure for modification of a configuration for multicast reception in the inactive state.

For example, an example procedure may be described as below.

Upon receiving the Paging message by the UE, the UE shall:
1> if in RRC_INACTIVE and the UE has joined one or more MBS session(s) indicated by the TMGI included in the pagingGroupList; and
1> if none of the ue-Identity included in any of the PagingRecord, if included in the Paging message, matches the UE identity allocated by upper layers:
   2> if pagingCause-MBS corresponding the MBS session indicated by the TMGI that UE has joined is set to modification:
      3> initiate random access process for MBS configuration update;
   2> if pagingCause-MBS corresponding the MBS session indicated by the TMGI that UE has joined is set to start:
      3> if the configuration of this MBS session is now available for the UE:
         4> apply the MBS configuration to receive MBS session while maintain in RRC_INACTIVE;
      3> else:
         4> initiate random access process for MBS configuration acquisition;
   2> if pagingCause-MBS corresponding the MBS session indicated by the TMGI that UE has joined is set to stop:
      3> if the UE is receiving the MBS session:
         4> stop monitoring this MBS session and store the MBS related configuration as UE Inactive AS Context.

For example, another example procedure may be described as below.

Upon receiving the Paging message by the UE, the UE shall:
1> if in RRC_INACTIVE and the UE has joined one or more MBS session(s) indicated by the TMGI included in the pagingGroupList; and
1> if none of the ue-Identity included in any of the PagingRecord, if included in the Paging message, matches the UE identity allocated by upper layers:
   2> if pagingCause-MBS corresponding the MBS session indicated by the TMGI that UE has joined is set to modification:
      3> initiate random access process for MBS configuration update;
   2> if pagingCause-MBS corresponding the MBS session indicated by the TMGI that UE has joined is set to start_INACTIVE:
      3> if the configuration of this MBS session is now available for the UE:
         4> apply the MBS configuration to receive MBS session while maintain in RRC_INACTIVE;
      3> else:
         4> initiate random access process for MBS configuration acquisition;
   2> if pagingCause-MBS corresponding the MBS session indicated by the TMGI that UE has joined is set to start_CONNECTED:
      4 initiate random access process for MBS configuration acquisition and receive MBS session while maintain in RRC_CONNECTED;
   2> if pagingCause-MBS corresponding the MBS session indicated by the TMGI that UE has joined is set to stop:
      3> if the UE is receiving the MBS session:
         4> stop monitoring this MBS session and store the MBS related configuration as UE Inactive AS Context.

In this way, each TMGI indication may be mapped to one of three types of notification, to let a UE in an inactive state know the current MBS session state.

### Example Implementation of Random Access

In some scenarios, when a UE in an inactive state is receiving a multicast session, a network may want to modify a configuration for multicast reception. However, there is no dedicated channel for a UE in an inactive state to receive a configuration for multicast reception.

In some scenarios, a UE supports multicast reception in an inactive state, but a configuration for multicast reception in the inactive state is unavailable to the UE, e.g., a multicast session may be not started yet. In this case, it is unclear whether to directly start a multicast session without entering a connected state.

In view of these scenarios, embodiments of the present disclosure provide a solution of multicast reception in an inactive state to solve the above and other potential issues. The solution will be detailed in connection with FIG. 4.

FIG. 4 illustrates a schematic diagram illustrating another process 400 of communication for multicast reception in an inactive state according to embodiments of the present disclosure. For the purpose of discussion, the process 400 will be described with reference to FIG. 1. The process 400 may involve the terminal device 110 and the network device 120 as illustrated in FIG. 1. It is to be understood that the steps and the order of the steps in FIG. 4 are merely for illustration, and not for limitation. For example, the order of the steps may be changed. Some of the steps may be omitted or any other suitable additional steps may be added. It is assumed that the terminal device 110 is in an inactive state.

As shown in FIG. 4, the terminal device 110 may transmit 410, to the network device 120, a message (for convenience, also referred to as a first message herein) for requesting a configuration for multicast reception in an inactive state.

In some embodiments, the first message may be an uplink common control channel (UL-CCCH) message. In some embodiments, the first message may comprise an identity of the terminal device 110. For example, the first message may comprise at least one of an inactive-radio network temporary identifier (I-RNTI), a fifth-generation system temporary mobile subscriber identity (5G-S-TMSI) or a cell-radio network temporary identifier (C-RNTI) of the terminal device 110. It is to be understood that the identity may also adopt any other suitable forms.

In some embodiments, the first message may comprise an indication indicating modification of the configuration. In some embodiments, the first message may comprise an indication indicating acquisition of the configuration. For example, the first message may comprise an indication indicating acquisition of the configuration in a connected state. In another example, the first message may comprise an indication indicating acquisition of the configuration in an inactive state.

For example, a new UL-CCCH or UL-CCCH1 message type (denoted as rrcMBSRequest herein) may be introduced as below.

| UL-CCCH1-Message ::= | SEQUENCE { [symbol] |
|---|---|
| message | UL-CCCH1-MesasageType [symbol] |
| } [symbol] | |
| [symbol] | |
| UL-CCCH1-MessageType ::= | CHOICE { [symbol] |
| c1 | CHOICE { |
| rrcResumeRequest1 | RRCResumeRequest1, |
| rrcMBSRequest | RRCMBSRequest, |

```
    spare2 NULL,
    spare1 NULL

[symbol]

  },
  messageClassExtension SEQUENCE [symbol]
} [symbol] [symbol]
indicates data missing or illegible when filed
```

In this example, RRCMBSRequest (i.e., the first message) is used for requesting a MBS related configuration. In some embodiments, when the terminal device 110 receives, from the network device 120, an indication (e.g., a paging message) indicating modification or start of a multicast session, the terminal device 110 may transmit the UL-CCCH1 message for MBS configuration acquisition or update. It is to be understood that this is merely an example, and the UL-CCCH1 message may be transmitted in any other suitable scenarios.

For example, the RRCMBSRequest message may be configured as below.

| | |
|---|---|
| RRCMBSRequest ::= | SEQUENCE { [symbol] |
| ue-Identity: | UE-Identity [symbol] |
| requestType | CHOICE [symbol] |
| mbsConfigurationAcquisition | ENUMERATED {true}, |
| mbsConfigurationUpdate | ENUMERATED {true} [symbol] |

} [symbol]
} [symbol] [symbol]
indicates data missing or illegible when filed

In this example, the RRCMBSRequest message may comprise UE-Identity. The UE-Identity may be at least one of I-RNTI, 5G-S-TMSI or C-RNTI. The RRCMBSRequest message may also comprise two information elements (IEs): mbsConfigurationAcquistition; mbsConfigurationUpdate.

mbsConfigurationAcquistition: used for MBS configuration acquisition. When the terminal device 110 receives paging message indicating session start, the terminal device 110 transmits RRCMBSRequest message with the IE mbsConfigurationAcquisition set to true.

mbsConfigurationUpdate: used for MBS configuration update. When the terminal device 110 receives paging message indicating session modification, the terminal device 110 transmits RRCMBSRequest message with the IE mbsConfigurationUpdate set to true.

In another example, a RRCMBSRequest message may be configured as below.

| | |
|---|---|
| RRCMBSRequest ::= | SEQUENCE { [symbol] |
| ue-Identity | UE-Identity |
| requestType | CHOICE { |
| mbsConfiqurationAquisition-CONNCETED | ENUMERATED {true}, |
| mbsConfigurationAcquisition-INACTIVE | ENUMERATED {true}, |
| mbsConfigurationUpdate | ENUMERATED {true} [symbol] |

} [symbol]
} [symbol] [symbol]
indicates data missing or illegible when filed

In this example, the RRCMBSRequest message may comprise UE-Identity. The UE-Identity may be at least one of I-RNTI, 5G-S-TMSI or C-RNTI. The RRCMBSRequest message may also comprise three IEs:
mbsConfigurationAcquistition-CONNECTED; mbsConfigurationAcquistition-INACTIVE; mbsConfigurationUpdate.
mbsConfigurationAcquistition-CONNECTED: used for MBS configuration acquisition in a connected state.
mbsConfigurationAcquistition-INACTIVE: used for MBS configuration acquisition in an inactive state.

When the terminal device 110 receives paging message indicating session start, the terminal device 110 sends RRCMBSRequest message with the IE mbsConfigurationAcquisition-CONNECTED or mbsConfigurationAcquistition-INACTIVE set to true. In this case, the terminal device 110 may provide a preference on MBS reception in a connected state or an inactive state to the network device 120.

mbsConfigurationUpdate: used for MBS configuration update. When the terminal device 110 receives paging message indicating session modification, the terminal device 110 transmits RRCMBSRequest message with the IE mbsConfigurationUpdate set to true.

It is to be understood that the above examples are merely for illustration, and are not intended for limitation. The first message may adopt any suitable forms.

In this way, a new UL-CCCH message may be introduced for random access to request MBS configuration without entering a connected state. Accordingly, UE in an inactive state is not required to fallback to a connected state to receive a new MBS configuration. Thus, power saving and latency reduction may be efficiently achieved.

In some embodiments, the first message may be a RRC resume request message comprising a resume cause, and the resume cause may indicate information of the configuration. In some embodiments, the information of the configuration may comprise modification of the configuration. In some embodiments, the information of the configuration may comprise acquisition of the configuration. For example, the information of the configuration may comprise acquisition of the configuration in a connected state. In another example, the information of the configuration may comprise acquisition of the configuration in an inactive state.

For example, a RRC resume request message may be configured as below.

| | |
|---|---|
| RRCResumeRequest-IEs ::= | SEQUENCE { [symbol] |
| resumeIdentity | ShortI-RNTI-Value, |
| resumeMAC-I | BIT STRING (SIZE (16)), |
| resumeCause | ResumeCause, [symbol] |
| spare | BIT STRING (SIZE (1)) [symbol] |

[symbol]

| | |
|---|---|
| [symbol] | ENUMERATED [symbol] |
| | [symbol] |
| | [symbol] spare1, spare2, spare3 [symbol] |

[symbol]

indicates data missing or illegible when filed

In this example, new resume causes mbs-Update and mbs-Acquistion is introduced.
mbs-Acquisition: used for MBS config acquisition, when UE receives network indication (e.g. paging message) that indicating the MBS session will be started, UE sends RRCResumeRequest with resumeCause set to this value.
mbs-Update: used for MBS config update, when UE receives network indication (e.g. paging message) that indicating the MBS configuration will be modified, UE sends RRCResumeRequest with resumeCause set to this value.

Optionally, for mbs-Acquisition, it may be divided into two types:
1. mbs-Acquisition-CONNECTED: UE prefers to receive the MBS session in RRC_CONNCTED when the session starts;
2. mbs-Acquisition-INACTIVE: UE prefers to receive the MBS session in RRC_INACTIVE when the session starts.

It is to be understood that the above example is merely for illustration, and is not intended for limitation. The resume cause may adopt any other suitable forms.

In this way, a new resume cause may be introduced into a RRC resume request message to request MBS configuration without entering a connected state. Accordingly, UE in an inactive state can indicate, to a network, that a resume reason is just for MBS configuration reception, probably no need to fallback to a connected state. Thus, power saving and latency reduction may also be efficiently achieved.

Continue to refer to FIG. 4, the network device 120 may transmit 420, to the terminal device 110, a RRC release message comprising the configuration.

In some embodiments, when the terminal device 110 sends RRCMBSRequest message with mbsConfigurationUpdate set to true, the network device 120 may send RRCRelease message to the terminal device 110 as a response. Among RRCRelease message, it includes newly (updated) MBS related configuration.

In some embodiments, when the terminal device 110 sends RRCMBSRequest message with mbsConfigurationAcquisition set to true, the network device 120 may, based on implementation, send RRCRelease message to provide MBS related configuration for MBS reception during an inactive state, or, send RRCResume message to let the terminal device 110 fallback to a connected state to receive the MBS related configuration.

In some embodiments where a new UL-CCCH message (e.g., a RRCMBSRequest message) is used, an example procedure may be described as below.

### <Omit Part>

Step 1. UE selects the contention-based preamble to perform the Random Access Preamble transmission procedure.
Step 2. UE receives a downlink assignment (i.e. Msg2-RAR MAC PDU) on the PDCCH for the RA-RNTI.
Step 3. UE process Time Advance Command, Power Ramping, UL Grant, TC-RNTI.

### <Omit Part>

After performing the above procedure, UE sends Msg3 by containing UL-CCCH (1) SDU with RRCMBSRequest message.

Once Msg3 is transmitted the MAC entity shall:
1> if notification of a reception of a PDCCH transmission of the SpCell is received from lower layers:
   2> if the MAC PDU is successfully decoded:
      3> stop ra-ContentionResolutionTimer;
      3> if the MAC PDU contains a UE Contention Resolution Identity MAC CE; and
      3> if the UE Contention Resolution Identity in the MAC CE matches the CCCH SDU transmitted in Msg3:
         4> consider this Contention Resolution successful and finish the disassembly and demultiplexing of the MAC PDU;
         4> if this Random Access procedure was initiated for MBS configuration update:
         5> process the reception of RRCRelease message for MBS configuration;
         4> if this Random Access procedure was initiated for MBS configuration acquisition:
         (opt 1) 5> process the reception of RRCRelease message for MBS configuration;
         (opt 2) 5> process the legacy RRC resumption procedure (i.e. enter RRC_CONNECTED).

In some embodiments where a new resume cause is used, an example procedure may be described as below.

### <Omit Part>

Step 1. UE selects the contention-based preamble to perform the Random Access
Preamble transmission procedure.

Step 2. UE receives a downlink assignment (Msg2/RAR MAC PDU) on the PDCCH for the RA-RNTI.
Step 3. UE process Time Advance Command, Power Ramping, UL Grant, TC-RNTI.

### <Omit Part>

After performing the above procedure, UE sends Msg3 by containing UL-CCCH(1) SDU with RRCResumeRequest message.

Once Msg3 is transmitted the MAC entity shall:
1> if notification of a reception of a PDCCH transmission of the SpCell is received from lower layers:
   2> if the MAC PDU is successfully decoded:
      3> stop ra-ContentionResolutionTimer;
      3> if the MAC PDU contains a UE Contention Resolution Identity MAC CE; and
      3> if the UE Contention Resolution Identity in the MAC CE matches the CCCH SDU transmitted in Msg3:
         4> consider this Contention Resolution successful and finish the disassembly and demultiplexing of the MAC PDU;
         4> if this Random Access procedure was initiated for MBS configuration update based on ResumeCause:
         5> process the reception of RRCRelease message for MBS configuration;
         4> if this Random Access procedure was initiated for MBS configuration acquisition based on ResumeCause:
         (opt 1) 5> process the reception of RRCRelease message for MBS configuration;
         (opt 2) 5> process the legacy RRC resumption procedure.

Furthermore, for MBS configuration acquisition (session start), another way is to let UE fallback to RRC_CONNECTED to receive MBS.

Continue to refer to FIG. 4, upon reception of the RRC release message, the terminal device 110 may apply 430 the configuration to receive a multicast session in the inactive state. In some alternative embodiments, the terminal device 110 may enter 440 a connected state to receive the multicast session based on the configuration.

In some embodiments where a new UL-CCCH message (e.g., a RRCMBSRequest message) is used, an example procedure may be described as below.
1> if the RRCRelease includes suspendConfig:
   2> if the RRCRelease message with suspendConfig was received in response to RRCMBSRequst with the mbsConfigurationUpdate set to true:
      3> replace the MBS related configuration with the new one received in this message.
      3> continue to receive the corresponding MBS session based on the new MBS configuration while maintain in RRC_INACTIVE.
   2> if the RRCRelease message with suspendConfig was received in response to RRCMBSRequst with the mbsConfigurationAcquisition set to true:
      3> apply the MBS related configuration received in this message.
      3> receive the corresponding MBS session based on the new MBS configuration while maintain in RRC_INACTIVE.
   2> . . .
   2> enter RRC_INACTIVE.

In some embodiments where a new resume cause is used, an example procedure may be described as below.
1> if the RRCRelease includes suspendConfig:
   2> if the RRCRelease message with suspendConfig was received in response to RRCResumeRequest with the ResumeCause set to mbs-Update:
      3> replace the MBS related configuration with the new one received in this message.
      3> continue to receive the corresponding MBS session based on the new MBS configuration while maintain in RRC_INACTIVE.
   2> if the RRCRelease message with suspendConfig was received in response to RRCResumeRequest with the ResumeCause set to mbs-Acquisition:
      3> apply the MBS related configuration received in this message.
      3> receive the corresponding MBS session based on the new MBS configuration while maintain in RRC_INACTIVE.
   2> . . .
   2> enter RRC_INACTIVE.

Furthermore, for MBS configuration acquisition (session start), another way is to let UE fallback RRC_CONNECTED to receive MBS.

With the process 400, a UE in an inactive state may receive a configuration for multicast reception without entering a connected state. Thus, power saving and latency reduction may be achieved.

It is to be understood that the process 300 and the process 400 may be performed separately or in any suitable combination.

### Example Implementation of Methods

Corresponding to the above processes, embodiments of the present disclosure provide methods of communication implemented at a terminal device. These methods will be described below with reference to FIGS. 5 to 8.

FIG. 5 illustrates an example method 500 of communication implemented at a terminal device in accordance with some embodiments of the present disclosure. For example, the method 500 may be performed at the terminal device 110 as shown in FIG. 1. For the purpose of discussion, in the following, the method 500 will be described with reference to FIG. 1. It is to be understood that the method 500 may include additional blocks not shown and/or may omit some blocks as shown, and the scope of the present disclosure is not limited in this regard.

At block 510, a terminal device in an inactive state (e.g., the terminal device 110) receives, from a network device (e.g., the network device 120), a paging message comprising a paging cause for a multicast session, the paging cause indicating a start, stop or modification of the multicast session.

At block 520, the terminal device 110 performs an operation for the multicast session based on the paging cause.

In some embodiments where the paging cause indicates the start of the multicast session or the start of the multicast session in the inactive state, if a configuration for multicast reception in the inactive state is available for the terminal device, the terminal device 110 may apply the configuration for reception of the multicast session in the inactive state. If the configuration is unavailable for the terminal device, the terminal device 110 may initiate a random access procedure for acquisition of the configuration.

In some embodiments where the paging cause indicates the start of the multicast session in a connected state, the terminal device 110 may initiate a random access procedure for acquisition of a configuration for multicast reception in the connected state, and receive the multicast session in the connected state based on the configuration.

In some embodiments where the paging cause indicates the stop of the multicast session, if the terminal device 110 is receiving the multicast session, the terminal device 110 may stop monitoring the multicast session, and store a configuration for the multicast session in the inactive state.

In some embodiments where the paging cause indicates the modification of the multicast session, the terminal device 110 may initiate a random access procedure for modification of a configuration for multicast reception in the inactive state.

In some embodiments, the terminal device 110 may receive, from the network device 120, downlink control information scheduling reception of the paging message, the downlink control information comprising an indication indicating that only multicast information is present in the downlink control information. If the terminal device 110 has not joined a multicast session in the inactive state, the terminal device 110 may skip the paging message.

With the method 500, more information may be comprised in a paging message and multicast reception in an inactive state may be well supported.

FIG. 6 illustrates another example method 600 of communication implemented at a terminal device in accordance with some embodiments of the present disclosure. For example, the method 600 may be performed at the terminal device 110 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

At block 610, a terminal device in an inactive state (e.g., the terminal device 110) transmits, to a network device (e.g., the network device 120), a first message for requesting a configuration for multicast reception in the inactive state.

In some embodiments, the first message may be an uplink common control channel message and may comprise an identity of the terminal device.

In some embodiments, the first message may further comprise at least one of the following: an indication indicating acquisition of the configuration; an indication indicating modification of the configuration; an indication indicating acquisition of the configuration in a connected state; or an indication indicating acquisition of the configuration in the inactive state.

In some embodiments, the first message may be a radio resource control resume request message comprising a resume cause, the resume cause indicating information of the configuration.

In some embodiments, the information of the configuration may comprise at least one of the following: acquisition of the configuration; modification of the configuration; acquisition of the configuration in a connected state; or acquisition of the configuration in the inactive state.

At block 620, the terminal device 110 receives, from the network device 130, a radio resource control release message comprising the configuration.

In some embodiments, the terminal device 110 may apply the configuration to receive a multicast session in the inactive state. In some embodiments, the terminal device 110 may enter a connected state to receive the multicast session based on the configuration.

With the method 600, a UE in an inactive state may receive a configuration for multicast reception without entering a connected state. Thus, power saving and latency reduction may be achieved.

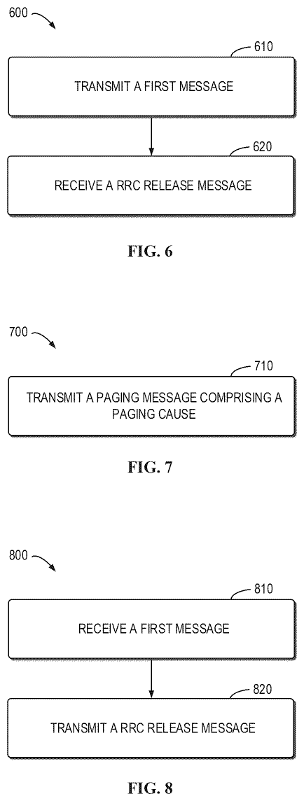

FIG. 7 illustrates an example method 700 of communication implemented at a network device in accordance with some embodiments of the present disclosure. For example, the method 700 may be performed at the network device 120 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

At block 710, a network device (e.g., the network device 120) transmits, to a terminal device in an inactive state (e.g., the terminal device 110), a paging message comprising a paging cause for a multicast session, the paging cause indicating a start, stop or modification of the multicast session.

In some embodiments, the start of the multicast session may comprise the start of the multicast session in the inactive state or the start of the multicast session in a connected state.

In some embodiments, the network device 120 may further transmit, to the terminal device 110, downlink control information scheduling reception of the paging message, the downlink control information comprising an indication indicating that only multicast information is present in the downlink control information.

With the method 700, more information may be comprised in a paging message and multicast reception in an inactive state may be well supported.

FIG. 8 illustrates another example method 800 of communication implemented at a network device in accordance with some embodiments of the present disclosure. For example, the method 800 may be performed at the network device 120 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, a network device (e.g., the network device 120) receives, from a terminal device in an inactive state (e.g., the terminal device 110), a first message for requesting a configuration for multicast reception in the inactive state.

In some embodiments, the first message may be an uplink common control channel message and may comprise an identity of the terminal device.

In some embodiments, the first message may further comprise at least one of the following: an indication indicating acquisition of the configuration; an indication indicating modification of the configuration; an indication indicating acquisition of the configuration in a connected state; or an indication indicating acquisition of the configuration in the inactive state.

In some embodiments, the first message may be a radio resource control resume request message comprising a resume cause, the resume cause indicating information of the configuration.

In some embodiments, the information of the configuration may comprise at least one of the following: acquisition of the configuration; modification of the configuration; acquisition of the configuration in a connected state; or acquisition of the configuration in the inactive state.

At block 820, the network device 130 transmits, to the terminal device 110, a radio resource control release message comprising the configuration.

In some embodiments, the network device 120 may indicate the terminal device 110 to apply the configuration to receive a multicast session in the inactive state. In some embodiments, the network device 120 may indicate the terminal device 110 to enter a connected state to receive the multicast session based on the configuration.

With the method 800, a UE in an inactive state may receive a configuration for multicast reception without entering a connected state. Thus, power saving and latency reduction may be achieved.

### Example Implementation of Device and Apparatus

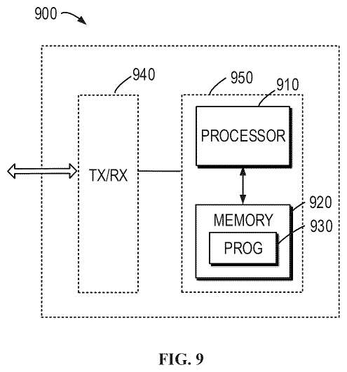

FIG. 9 is a simplified block diagram of a device 900 that is suitable for implementing embodiments of the present disclosure. The device 900 can be considered as a further example implementation of the terminal device 110 or the network device 120 as shown in FIG. 1. Accordingly, the device 900 can be implemented at or as at least a part of the terminal device 110 or the network device 120.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 930 is assumed to include program instructions that, when executed by the associated processor 910, enable the device 900 to operate in accordance with the embodiments of the present disclosure, as discussed herein with reference to FIGS. 1 to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In some embodiments, a terminal device comprises a circuitry configured to: receive, in an inactive state and from a network device, a paging message comprising a paging cause for a multicast session, the paging cause indicating a start, stop or modification of the multicast session; and perform an operation for the multicast session based on the paging cause.

In some embodiments, a terminal device comprises a circuitry configured to: transmit, in an inactive state and to a network device, a first message for requesting a configuration for multicast reception in the inactive state; and receive, from the network device, a radio resource control release message comprising the configuration.

In some embodiments, a network device comprises a circuitry configured to: transmit, to a terminal device in an inactive state, a paging message comprising a paging cause for a multicast session, the paging cause indicating a start, stop or modification of the multicast session.

In some embodiments, a network device comprises a circuitry configured to: receive, from a terminal device in an inactive state, a first message for requesting a configuration for multicast reception in the inactive state; and transmit, to the terminal device, a radio resource control release message comprising the configuration.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a method of communication comprises: receiving, at a terminal device in an inactive state and from a network device, a paging message comprising a paging cause for a multicast session, the paging cause indicating a start, stop or modification of the multicast session; and performing an operation for the multicast session based on the paging cause.

In some embodiments, the paging cause indicates the start of the multicast session or the start of the multicast session in the inactive state. In these embodiments, performing the operation for the multicast session comprises: in accordance with a determination that a configuration for multicast reception in the inactive state is available for the terminal device, applying the configuration for reception of the multicast session in the inactive state; or in accordance with a determination that the configuration is unavailable for the terminal device, initiating a random access procedure for acquisition of the configuration.

In some embodiments, the paging cause indicates the start of the multicast session in a connected state. In these embodiments, performing the operation for the multicast session comprises: initiating a random access procedure for acquisition of a configuration for multicast reception in the connected state; and receiving the multicast session in the connected state based on the configuration.

In some embodiments, the paging cause indicates the stop of the multicast session. In these embodiments, performing the operation for the multicast session comprises: in accordance with a determination that the terminal device is receiving the multicast session, stopping monitoring the multicast session; and storing a configuration for the multicast session in the inactive state.

In some embodiments, the paging cause indicates the modification of the multicast session. In these embodiments, performing the operation for the multicast session comprises: initiating a random access procedure for modification of a configuration for multicast reception in the inactive state.

In some embodiments, the method above further comprises: receiving, from the network device, downlink control information scheduling reception of the paging message, the downlink control information comprising an indication indicating that only multicast information is present in the downlink control information; and in accordance with a determination that the terminal device has not joined a multicast session in the inactive state, skipping the paging message.

In another solution, a method of communication comprises: transmitting, at a terminal device in an inactive state and to a network device, a first message for requesting a configuration for multicast reception in the inactive state; and receiving, from the network device, a radio resource control release message comprising the configuration.

In some embodiments, the first message is an uplink common control channel message and comprises an identity of the terminal device.

In some embodiments, the first message further comprises at least one of the following: an indication indicating acquisition of the configuration; an indication indicating modification of the configuration; an indication indicating acquisition of the configuration in a connected state; or an indication indicating acquisition of the configuration in the inactive state.

In some embodiments, the first message is a radio resource control resume request message comprising a resume cause, the resume cause indicating information of the configuration.

In some embodiments, the information of the configuration comprises at least one of the following: acquisition of the configuration; modification of the configuration; acquisition of the configuration in a connected state; or acquisition of the configuration in the inactive state.

In some embodiments, the method above further comprises: applying the configuration to receive a multicast session in the inactive state; or entering a connected state to receive the multicast session based on the configuration.

In another solution, a method of communication comprises: transmitting, at a network device and to a terminal device in an inactive state, a paging message comprising a paging cause for a multicast session, the paging cause indicating a start, stop or modification of the multicast session.

In some embodiments, the method above further comprises: transmitting, to the terminal device, downlink control information scheduling reception of the paging message, the downlink control information comprising an indication indicating that only multicast information is present in the downlink control information.

In some embodiments, the start of the multicast session comprises the start of the multicast session in the inactive state or the start of the multicast session in a connected state.

In another solution, a method of communication comprises: receiving, at a network device and from a terminal device in an inactive state, a first message for requesting a configuration for multicast reception in the inactive state; and transmitting, to the terminal device, a radio resource control release message comprising the configuration.

In some embodiments, the first message is an uplink common control channel message and comprises an identity of the terminal device.

In some embodiments, the first message further comprises at least one of the following: an indication indicating acquisition of the configuration; an indication indicating modification of the configuration; an indication indicating acquisition of the configuration in a connected state; or an indication indicating acquisition of the configuration in the inactive state.

In some embodiments, the first message is a radio resource control resume request message comprising a resume cause, the resume cause indicating information of the configuration.

In some embodiments, the information of the configuration comprises at least one of the following: acquisition of the configuration; modification of the configuration; acquisition of the configuration in a connected state; or acquisition of the configuration in the inactive state.

In some embodiments, transmitting the radio resource control release message comprises: indicating the terminal device to apply the configuration to receive a multicast session in the inactive state; or indicating the terminal device to enter a connected state to receive the multicast session based on the configuration.

In another solution, a device of communication comprises: a processor configured to cause the device to perform the method according to any of the above methods.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-13. (canceled)

14. A method performed by a terminal device, the method comprising:
receiving a paging message; and
monitoring a group-radio network temporary identifier (G-RNTI) in a case where:
the terminal device is in radio resource control (RRC) inactive state and the terminal device has joined one or more multicast and broadcast service (MBS) sessions indicated by temporary mobile group identifier (TMGI)(s) included in the paging message,
the terminal device has a configuration for multicast reception in RRC inactive state, and
the paging message comprises first information for at least one of the MBS sessions indicated by the TMGI(s) that the terminal device has joined, wherein the first information indicates that the terminal device with the configuration is in RRC inactive state to receive a corresponding MBS multicast session.

15. The method of claim 14, further comprising: initiating a random access procedure for the multicast reception in a case where:
the terminal device is in RRC inactive state and the terminal device has joined one or more MBS session(s) indicated by TMGI(s) included in the paging message, and
the terminal device does not have the configuration for multicast reception in RRC inactive state.

16. The method of claim 14, wherein the monitoring the G-RNTI further comprises: monitoring the G-RNTI in a further case where none of a user equipment (UE) Identity included in the paging message matches a UE identity allocated by upper layers.

17. A method performed by a network device, the method comprising:
transmitting a configuration for multicast reception in radio resource control (RRC) inactive state;
transmitting a paging message,
wherein the paging message comprises first information for at least one of multicast and broadcast service (MBS) sessions indicated by temporary mobile group identifier (TMGI) (s) that the terminal device has joined, wherein the first information indicates that the terminal device with the configuration is in RRC inactive state to receive a corresponding MBS multicast session; and
transmitting downlink control information (DCI) with a group-radio network temporary identifier (G-RNTI).

18. A terminal device, comprising a processor configured to:
receive a paging message; and
monitor a group-radio network temporary identifier (G-RNTI) in a case where:
the terminal device is in radio resource control (RRC) inactive state and the terminal device has joined one or more multicast and broadcast service (MBS) sessions indicated by temporary mobile group identifier (TMGI) (s) included in the paging message,
the terminal device has a configuration for multicast reception in RRC inactive state, and
the paging message comprises first information for at least one of the MBS sessions indicated by the TMGI(s) that the terminal device has joined, wherein the first information indicates that the terminal device with the configuration is in RRC inactive state to receive a corresponding MBS multicast session.

19. The terminal device of claim 18, wherein the processor is further configured to cause the terminal device to initiate a random access procedure for the multicast reception in a case where:
the terminal device is in RRC inactive state and the terminal device has joined one or more MBS session(s) indicated by TMGI(s) included in the paging message, and
the terminal device does not have the configuration for multicast reception in RRC inactive state.

20. The terminal device of claim 18, wherein the processor is configured to monitor the G-RNTI in a further case where none of a user equipment (UE) Identity included in the paging message matches a UE identity allocated by upper layers.
